(19) United States
(12) Patent Application Publication
(10) Pub. No.: US 2022/0260175 A1
(43) Pub. Date: Aug. 18, 2022

(54) ELECTROMAGNETIC VALVE

(71) Applicant: SMC CORPORATION, Chiyoda-ku (JP)

(72) Inventors: Yoshiyuki TAKADA, Ichikawa-shi (JP); Shinichi YOSHIMURA, Moriya-shi (JP); Minehiko MITA, Joso-shi (JP); Kazuhiro UMEDA, Noda-shi (JP)

(73) Assignee: SMC CORPORATION, Chiyoda-ku (JP)

(21) Appl. No.: 17/627,559

(22) PCT Filed: Jul. 13, 2020
(86) PCT No.: PCT/JP2020/027184

§ 371 Date: Jan. 14, 2022

(30) Foreign Application Priority Data
Jul. 17, 2019 (JP) 2019-132245

(51) Int. Cl. F16K 31/06

(52) U.S. Cl. CPC F16K 31/0675; F16K 27/003; F16K 31/0655

(57) ABSTRACT

An electromagnetic operation part of an electromagnetic valve includes a bobbin, a fixed iron core, a movable iron core, a return spring, a magnetic cover, and a magnetic plate. A coil is would around the bobbin. The fixed iron core and the movable iron core are housed in a bobbin hole extending through the bobbin. The return spring places the movable iron core back into an initial position. The magnetic cover covers the electromagnetic operation part. The magnetic plate provides magnetic coupling between the magnetic cover and the movable iron core. The fixed iron core has a spring housing hole extending within and through the fixed iron core. The return spring is housed in the spring housing hole. A proximal end of the return spring is in contact with the magnetic cover, and a distal end of the return spring is in contact with the movable iron core.

### TECHNICAL FIELD

The present invention relates to an electromagnetic valve including a main valve part and an electromagnetic operation part. The main valve part includes a valve member for switching between flow paths, and the electromagnetic operation part causes the valve member to perform switching.

### BACKGROUND ART

Such an electromagnetic valve is well known. For example, an electromagnetic valve disclosed in Patent Literature (PTL) 1 includes a main valve part and an electromagnetic operation part. The main valve part includes a valve member for switching between flow paths, and the electromagnetic operation part causes the valve member to perform switching. The electromagnetic operation part of the electromagnetic valve includes a hollow bobbin with a coil wound around it, a fixed iron core fixed in a center hole of the bobbin, a movable iron core housed in the center hole in a manner so as to be shiftable therein, and a return spring that places the movable iron core back into its initial position. When the coil is energized, the movable iron core is attracted to the fixed iron core by a magnetic force generated in the fixed iron core. When the coil is de-energized, the movable iron core is placed back into its initial position by the return spring. The reciprocating motion of the movable iron core causes the valve member to perform switching.

The return spring in the electromagnetic valve is typically disposed between a cap attached to a distal end of the movable iron core and a distal end portion of the bobbin in such a manner that the return spring in coil form extends all along the periphery of the distal end portion of the movable iron core.

The distance between the distal end portion of the bobbin and the cap is so short that a long return spring (a spring with a large number of active turns) is unfit for the well-known electromagnetic valve. Such an electromagnetic valve inevitably includes a return spring with a small number of active turns, that is, a return spring with a high spring constant. The loads applied to the movable iron core by the return spring can be nonuniform such that the functioning of the movable iron core can be adversely affected.

An electromagnetic valve disclosed in PTL 2 includes a return spring disposed between a recess in a fixed iron core and an end portion of a movable iron core. An electromagnetic valve disclosed in PTL 3 includes a return spring disposed between a recess in a movable iron core and a magnetic cover.

In these cases, the recess provides barely enough space for a short return spring, that is, a return spring of with a small number of active turns and a high spring constant. In this respect, the downside of the electromagnetic valve disclosed in PTL 2 and the electromagnetic valve disclosed in PTL 3 is similar to that of the electromagnetic valve disclosed in PTL 1.

### CITATION LIST

### Patent Literature

PTL 1: Japanese Patent No. 4310548
PTL 2: Japanese Examined Utility Model Registration Application Publication No. 2-5167
PTL 3: Japanese Examined Utility Model Registration Application Publication No. 4-43659

### SUMMARY OF INVENTION

### Technical Problem

The present invention addresses the technical problem of providing an electromagnetic valve including a return spring with a large number of active turns and a low spring constant to eliminate or reduce the nonuniformity in loads applied to a movable iron core by the return spring such that the functioning of the movable iron core will be highly stable.

### Solution to Problem

To solve the aforementioned problem, an electromagnetic valve according to the present invention includes a main valve part and an electromagnetic operation part. The main valve part includes a valve member for switching between flow paths, and the electromagnetic operation part causes the valve member to perform switching.

The electromagnetic operation part includes a bobbin, a bobbin hole, a fixed iron core, a movable iron core, a return spring, a magnetic cover, and a magnetic plate. A coil is wound around the bobbin. The bobbin hole extends within and through the bobbin from a proximal end to a distal end of the bobbin. The fixed iron core is fixedly housed in the bobbin hole in such a manner that a proximal end of the fixed iron core is adjacent to the proximal end of the bobbin hole. The movable iron core is housed in the bobbin hole in such a manner that a distal end of the movable iron core is adjacent to the distal end of the bobbin. The movable iron core is capable of shifting along an axis of the bobbin hole. The return spring is in coil form and places the movable iron core back into an initial position in which the movable iron core sits apart from the fixed iron core. The magnetic cover covers the proximal end of the bobbin, the proximal end of the fixed iron core, and the coil. The magnetic plate is adjacent to a distal end portion of the bobbin to provide magnetic coupling between the magnetic cover and the movable iron core. The magnetic plate has a plate hole in which the movable iron core is fitted in a manner so as to be shiftable therein. The fixed iron core has a spring housing hole extending within and through the fixed iron core along the axis. The return spring is housed in the spring housing hole. A proximal end of the return spring is in contact with the magnetic cover, and a distal end of the return spring is in contact with the movable iron core.

According to the present invention, the movable iron core may have an iron core hole extending within and through the movable iron core along the axis, and the distal end of the return spring may be in contact with a proximal end surface of the movable iron core in a manner so as to surround an open end of the iron core hole in the proximal end surface.

In this case, the iron core hole preferably includes a small-diameter portion having an open end in the proximal end surface of the movable iron core and a large-diameter portion having an open end in a distal end surface of the movable iron core. The inner diameter of the small-diameter portion is preferably smaller than the inner diameter of the large-diameter portion and is preferably smaller than the inner diameter of the spring housing hole in the fixed iron core.

According to the present invention, the magnetic cover and a recessed spring washer are preferably provided as a one-piece member in such a manner that the recessed spring washer is located in a contact portion where the return spring is in contact with the magnetic cover, and the movable iron core and another recessed spring washer are preferably provided as a one-piece member in such a manner that the recessed spring washer is located in a contact portion where the return spring is in contact with the movable iron core.

According to the present invention, the main valve part includes a valve body, an orifice, and a valve chamber. The valve body includes a plurality of ports. The orifice is attached to a proximal end portion that is part of the valve body and faces the electromagnetic operation part. The valve chamber is provided between the orifice and the valve body. Flow path cavities communicating with the respective ports are open to the valve chamber. The valve member for opening and closing the flow path cavities is housed in the valve chamber. The orifice includes a guide portion being tubular in shape and extending all along a periphery of a distal end portion of the movable iron core. The guide portion is caught in a recessed groove extending along an inner periphery of the magnetic plate. The inner diameter of the guide portion and the inner diameter of the bobbin hole are each smaller than the inner diameter of the plate hole in the magnetic plate.

In this case, the length of fit between the distal end portion of the movable iron core and the guide portion of the orifice in a direction of the axis in a state in which the movable iron core is in the initial position is preferably greater than a stroke of the movable iron core.

### Advantageous Effects of Invention

The spring housing hole is provided in the fixed iron core in a manner so as to extend through the fixed iron core, and the return spring is housed in the spring housing hole, with two ends of the return spring being in contact with the magnetic cover and the movable iron core, respectively. The present invention thus yields improvements in the following respects: a return spring with a large number of active turns and a low spring constant is included such that the nonuniformity in loads imposed on the movable iron core is reduced, and more stable functioning of the movable iron core is ensured accordingly.

### BRIEF DESCRIPTION OF DRAWINGS

FIG. 1 is a front view of an electromagnetic valve according to an embodiment of the present invention.

FIG. 2 is a right-hand side view of the electromagnetic valve illustrated in FIG. 1.

FIG. 3 is a sectional view of the electromagnetic valve taken along line in FIG. 1.

FIG. 4 is a sectional view of the electromagnetic valve taken along line IV-IV in FIG. 2.

### DESCRIPTION OF EMBODIMENTS

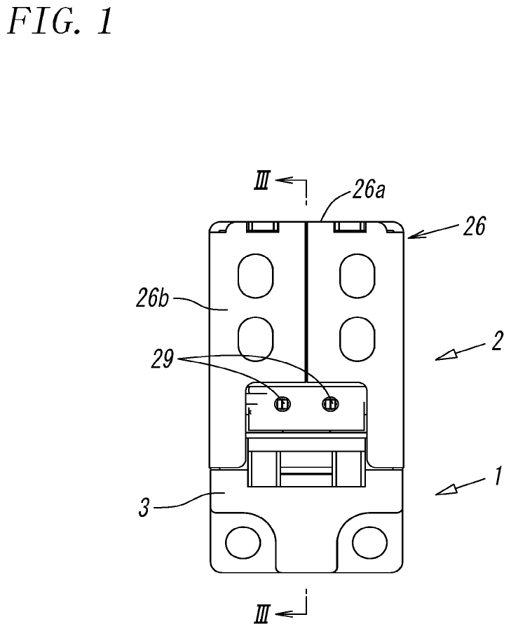

FIGS. 1 to 4 illustrate an electromagnetic valve that is a three-port valve including a main valve part 1 and an electromagnetic operation part 2. The main valve part 1 includes a valve member 8 for switching between flow paths, and the electromagnetic operation part 2 causes the valve member 8 to perform switching. The main valve part 1 and the electromagnetic operation part 2 are joined in series along an axis L. The axis L passes through the center of a bobbin hole 21 in the midsection of a bobbin 20.

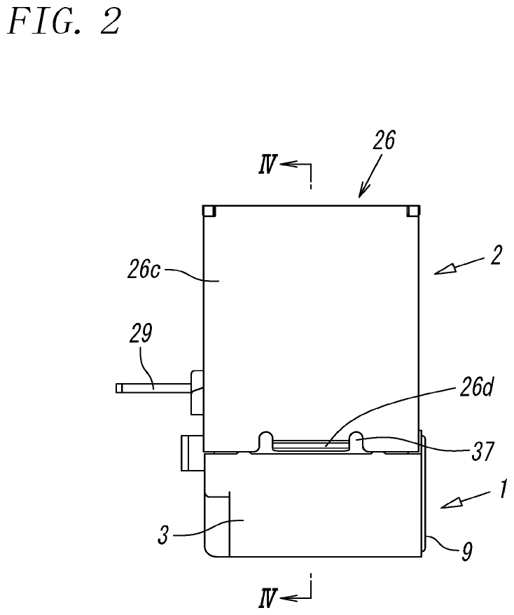

Regarding each component of the electromagnetic valve, the term “proximal end” hereinafter refers to an end portion closer to the upper side in FIGS. 1 and 2, and the term “distal end” hereinafter refers to an end portion closer to the lower side in FIGS. 1 and 2.

The main valve part 1 includes a valve body 3 and an orifice 4. The valve body 3 is made of a non-magnetic material. The orifice 4 is attached to the valve body 3 and is made of a non-magnetic material.

The valve body 3 is shaped like a rectangular block and has a first end (distal end) 3a and a second end (proximal end) 3b, which are located on opposite sides in the direction of the axis L. The electromagnetic operation part 2 is joined to the second end 3b. The valve body 3 has a valve cavity 5, which is located in the second end 3b of the valve body 3. The valve cavity 5 is shaped like a hollow cylinder and is dented toward the first end 3a. The orifice 4 is cylindrical and is fitted in the valve cavity 5 with an O ring 6 therebetween. With the orifice 4 being fitted in this manner, a valve chamber 7 is defined in the valve cavity 5. The valve chamber 7 is circular in shape and is enclosed with the orifice 4 and the valve body 3. The valve member 8 is housed in the valve chamber 7.

The valve body 3 has a mounting surface 3c, which is a side surface for mounting on a manifold (not illustrated). A supply port P, an output port A, and a discharge port R are arranged in a line on the mounting surface 3c in this order in the direction from the first end 3a toward the second end 3b. A gasket 9 is also attached to the mounting surface 3c.

A first flow path cavity 11, a second flow path cavity 12, and a third flow path cavity 13 are open to the valve chamber 7. The first flow path cavity 11 and the second flow path cavity 12 are opposite on the axis L. The first flow path cavity 11 is provided in the valve body 3, and the second flow path cavity 12 is provided in the orifice 4. The first flow path cavity 11 communicates with the supply port P through a communication cavity 11a in the valve body 3. The second flow path cavity 12 communicates with the discharge port R through the orifice 4 and a communication cavity 12a in the valve body 3. The third flow path cavity 13 is provided in a side surface of the valve chamber 7 and communicates with the output port A through a communication cavity 13a in the valve body 3.

The valve member 8 is in the form of a short cylinder made of rubber or synthetic rubber. The valve member 8 is fitted in a valve holder 14, which is in the form of a hollow cylinder and is made of synthetic resin. The valve member 8 is held by the valve holder 14 accordingly. The valve member 8 is pressed toward the second flow path cavity 12 all the time by a valve return spring 15, which is disposed between the valve member 8 and the valve body 3.

The valve holder 14 is provided with a pair of pushrods 14a. The pushrods 14a extend in parallel, and the valve holder 14 and the pair of pushrods 14a are provided as a one-piece member. The pushrods 14a extend toward the electromagnetic operation part 2 along the axis L through rod holes 16, which are provided in the orifice 4. Proximal ends of the pushrods 14a protrude through a surface of the orifice 4 toward the electromagnetic operation part 2 and are in contact with a distal end of a movable iron core 23.

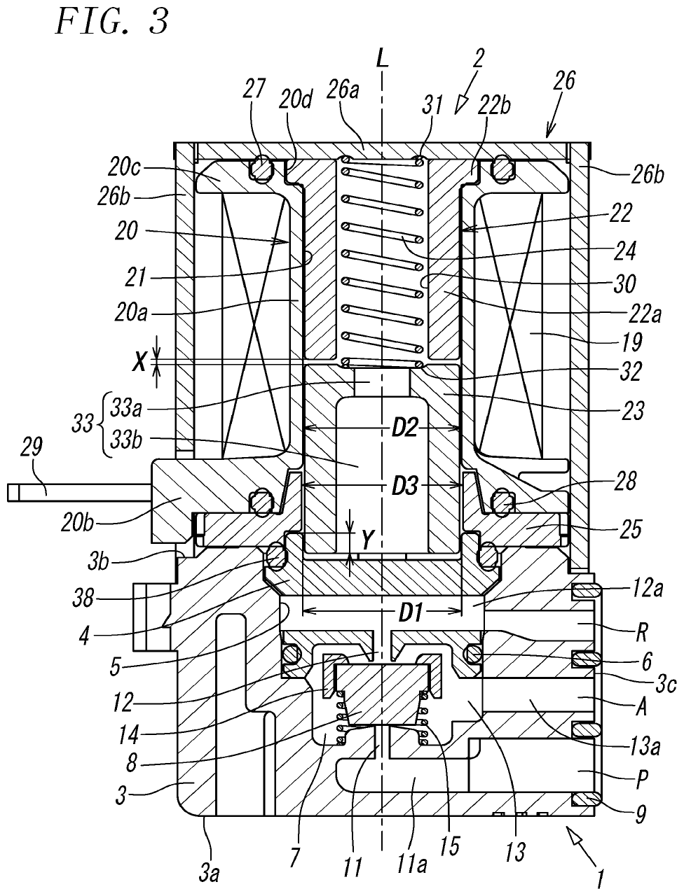

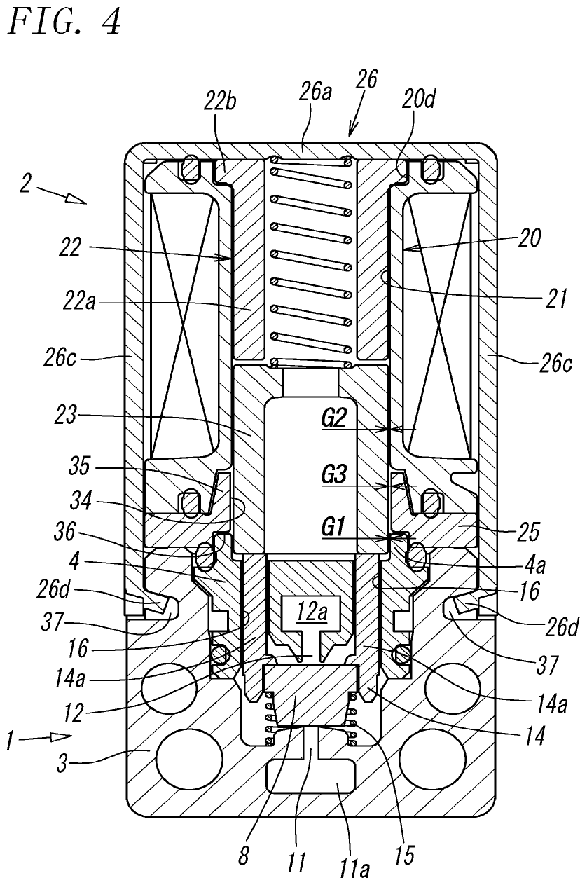

The electromagnetic operation part 2 includes the bobbin 20, the bobbin hole 21, a fixed iron core 22, the movable iron core 23, a return spring 24, a magnetic plate 25, and a magnetic cover 26. The bobbin 20 is made of a non-magnetic material and is hollow. A coil 19 is wound around the bobbin 20. The bobbin hole 21 extends through a midsection of the bobbin 20 along the axis L from a proximal end to a distal end of the bobbin 20. The fixed iron core 22 is fixedly housed in the bobbin hole 21 in such a manner that a proximal end of the fixed iron core 22 is adjacent to the proximal end of the bobbin 20. The movable iron core 23 is housed in the bobbin hole 21 in such a manner that a distal end of the movable iron core 23 is adjacent to the distal end of the bobbin 20, and the movable iron core 23 is capable of shifting along the axis L of the bobbin hole 21. The return spring 24 is in coil form and places the movable iron core 23 back into an initial position (illustrated in FIGS. 3 and 4) in which the movable iron core 23 sits apart from the fixed iron core 22. The magnetic plate 25 is provided to a distal end portion of the bobbin 20. The magnetic cover 26 is hollow and covers the entirety of the electromagnetic operation part 2.

The bobbin 20 includes a bobbin main body 20a, a first flange 20b, and a second flange 20c. The bobbin main body 20a is in the form of a hollow cylinder, and the coil 19 is wound along the periphery of the bobbin main body 20a. The first flange 20b is provided to a distal end of the bobbin main body 20a. The second flange 20c is provided to a proximal end of the bobbin main body 20a. The second flange 20c is in contact with an inner surface of a top plate 26a of the magnetic cover 26, with a sealing member 27 being disposed therebetween. The first flange 20b is in contact with a proximal end surface of the magnetic plate 25, with a sealing member 28 being disposed therebetween. A pair of coil terminals 29 protrudes laterally through a side surface of the first flange 20b. The coil terminals 29 are electrically connected to the coil 19.

The fixed iron core 22 is in the form of a cylinder made of a magnetic material such as iron and includes iron core main body 22a and a fixation flange 22b. The diameter of the iron core main body 22a is uniform throughout the length of the iron core main body 22a. The fixation flange 22b is provided to a proximal end of the iron core main body 22a. The diameter of the fixation flange 22b is greater than the diameter of the iron core main body 22a. The fixation flange 22b is fitted into a recessed step portion 20d, which extends along the inner periphery of the second flange 20c of the bobbin 20 such that the fixation flange 22b is held between a base of the recessed step portion 20d and the top plate 26a of the magnetic cover 26. The fixed iron core 22 is fixed in the bobbin hole 21 in the bobbin 20 accordingly.

The fixed iron core 22 has a spring housing hole 30. The spring housing hole 30 is circular and extends along the axis L through the movable iron core 23 from the proximal end to the distal end of the movable iron core 23, with the inner diameter of the spring housing hole 30 being constant throughout the length of the movable iron core 23. The return spring 24 is housed in the spring housing hole 30. A proximal end of the return spring 24 is in contact with a spring washer 31, which is recessed in the inner surface of the top plate 26a of the magnetic cover 26. The spring washer 31 and the top plate 26a are provided as a one-piece member. A distal end of the return spring 24 is in contact with a spring washer 32, which is recessed in a proximal end surface of the movable iron core 23. The spring washer 32 and the movable iron core 23 are provided as a one-piece member.

With one end portion of the return spring 24 being in contact with the spring washer 31 in the magnetic cover 26 and the other end portion of the return spring 24 being in contact with the spring washer 32 in the movable iron core 23, lateral misalignment of the return spring 24 is restricted, and the return spring 24 is kept from contact with a side wall defining the spring housing hole 30 in the fixed iron core 22.

The movable iron core 23 is in the form of a cylinder made of a magnetic material such as iron. The diameter of the movable iron core 23 is constant throughout the length of the movable iron core 23. The diameter of the movable iron core 23 is equal to or slightly smaller than the diameter of the iron core main body 22a of the fixed iron core 22 and is slightly smaller than the inner diameter of the bobbin hole 21 in the bobbin 20.

The movable iron core 23 has an iron core hole 33, which extends within and through the movable iron core 23 along the axis L. The iron core hole 33 includes a small-diameter portion 33a and a large-diameter portion 33b. The small-diameter portion 33a has an open end in the proximal end surface of the movable iron core 23. The large-diameter portion 33b has an open end in a distal end surface of the movable iron core 23. The inner diameter of the small-diameter portion 33a is smaller than the inner diameter of the large-diameter portion 33b. The inner diameter of the large-diameter portion 33b is substantially equal to the inner diameter of the spring housing hole 30 in the fixed iron core 22. The inner diameter of the small-diameter portion 33a is smaller than the inner diameter of the return spring 24. Thus, the spring washer 32 in the proximal end surface of the movable iron core 23 surrounds the small-diameter portion 33a having an open end in the proximal end surface. Similarly, a distal end portion of the return spring 24 is in contact with the proximal end surface of the movable iron core 23 in a manner so as to surround the small-diameter portion 33a of the iron core hole 33.

The length of the small-diameter portion 33a of the iron core hole 33 in the axial direction is smaller than the length of the large-diameter portion 33b in the axial direction and is preferably in the range of about one-half to about one-eighth of the length of the large-diameter portion 33b in the axial direction.

In some embodiments, the iron core hole 33 may include the small-diameter portion 33a only. That is, the iron core hole 33 equal in diameter to the small-diameter portion 33a may extend within and through the movable iron core 23.

As described above, the spring housing hole 30 is provided in the fixed iron core 22 in a manner so as to extend through the fixed iron core 22, and the return spring 24 is housed in the spring housing hole 30. This yields improvements in the following respects: the return spring 24 longer than the return spring of the well-known electromagnetic valve or, more specifically, the return spring 24 with a large number of active turns and a low spring constant is included such that the nonuniformity in loads applied to the movable iron core 23 by the return spring 24 is reduced, and more accurate functioning of the movable iron core 23 is ensured accordingly.

Due to the presence of the iron core hole 33, the movable iron core 23 is lightweight and is thus more impact resistant and more vibration resistant.

Similarly, the fixed iron core 22 is lightweight due to the presence of the spring housing hole 30. Combined with the lightness of the movable iron core 23, this leads to a reduction in the overall weight of the electromagnetic valve and results in savings in material use.

The magnetic plate 25 is a member for providing magnetic coupling between the magnetic cover 26 and the movable iron core 23. The magnetic plate 25 is made of a magnetic material such as iron and is rectangular when viewed in plan. The magnetic plate 25 has a plate hole 34, which is circular and is located at the center of the magnetic plate 25. The movable iron core 23 is fitted in the plate hole 34 in a manner so as to be capable of shifting along the axis L.

A tube 35 extends along an inner circumferential portion of the magnetic plate 25 and protrudes through a proximal end surface of the magnetic plate 25. The tube 35 is provided so that the area of an overlap between an inner circumferential surface defining the plate hole 34 and an outer circumferential surface of the movable iron core 23 is increased in the direction of the axis L.

A recessed groove 36 extends annularly along the inner circumference of a distal end portion of the magnetic plate 25. A guide portion 4a, which is part of the orifice 4 and is tubular in shape, is caught in the recessed groove 36. A distal end portion of the movable iron core 23 is fitted in the guide portion 4a in a manner so as to be capable of shifting along the axis L.

The guide portion 4a extends on a proximal end surface of the orifice 4 in such a manner that the guide portion 4a and the bobbin hole 21 in the bobbin 20 have a common axis. The height of the guide portion 4a in the direction of the axis L is greater than the depth of the recessed groove 36.

D1 and D2 are each smaller than D3, where D1, D2, and D3 respectively denote the inner diameter of the guide portion 4a, the inner diameter of the bobbin hole 21, and the inner diameter of the plate hole 34. Therefore, G1 and G2 are each smaller than G3, where G1, G2, and G3 respectively denote the gap between an inner circumferential surface of the guide portion 4a and the outer circumferential surface of the movable iron core 23, the gap between an inner circumferential surface defining the bobbin hole 21 and the outer circumferential surface of the movable iron core 23, and the gap between the inner circumferential surface defining the plate hole 34 and the outer circumferential surface of the movable iron core 23. The inner diameter D1 of the guide portion 4a and the inner diameter D2 of the bobbin hole 21 may be equal to each other or may be slightly different from each other.

Y is greater than X, where X denotes a stroke of the movable iron core 23, and Y denotes the length of fit between the distal end portion of the movable iron core 23 and the guide portion 4a of the orifice 4 in the direction of the axis L in a state in which the movable iron core 23 is in the initial position where the movable iron core 23 sits apart from the fixed iron core 22.

The magnetic cover 26 is in the form of a rectangular box made of a magnetic material such as iron. The magnetic cover 26 includes the top plate 26a, two side plates 26b, and two side plates 26c. The top plate 26a covers the proximal end of the bobbin 20 and the proximal end of the fixed iron core 22. The side plates 26b are located on the front side and the back side, respectively. The side plates 26c are located on the right side and the left side, respectively. The side surface of the coil 19 and the side surface of the magnetic plate 25 are entirely covered with the side plates 26b and 26c. Distal ends of the side plates 26c on the right and left sides are each provided with a catch portion 26d. Each catch portion 26d is tucked and caught in the corresponding catch recess 37, which is provided in a side surface of a proximal end portion of the valve body 3. The electromagnetic operation part 2 is joined to the main valve part 1 accordingly. In this state, the proximal end portion of the valve body 3 is in contact with a distal end surface of the magnetic plate 25, and a joint between the main valve part 1 and the electromagnetic operation part 2 is sealed with an O ring 38, which is disposed between the magnetic plate 25 and the orifice 4.

The magnetic cover 26 is obtained by folding an iron plate into the shape of a box. In some embodiments, the magnetic cover 26 may be a deep-drawn box made of an iron plate.

Referring to FIGS. 3 and 4, when the coil 19 of the electromagnetic valve structured as above is de-energized, the spring force of the return spring 24 keeps the movable iron core 23 in the initial position in which the movable iron core 23 sits apart from the fixed iron core 22. The movable iron core 23 pushes the pushrods 14a, which in turn causes the valve member 8 to close the first flow path cavity 11 and to open the second flow path cavity 12. Consequently, the supply port P is blocked, and the output port A and the discharge port R are brought into communication with each other.

When the coil 19 is energized, the fixed iron core 22, the movable iron core 23, the magnetic cover 26, and the magnetic plate 25 in the above state form a magnetic circuit such that the movable iron core 23 is attracted to the fixed iron core 22 in a manner so as to compress the return spring 24. In step with this, the valve return spring 15 pushes the valve member 8 toward the second flow path cavity 12, causing the valve member 8 to open the first flow path cavity 11 and to close the second flow path cavity 12. Consequently, the supply port P and the output port A are brought into communication with each other, and the discharge port R is blocked.

The inner diameter D1 of the guide portion 4a and the inner diameter D2 of the bobbin hole 21 are each smaller than the inner diameter D3 of the plate hole 34 in the magnetic plate 25. Thus, the movable iron core 23 of the electromagnetic valve is guided by the guide portion 4a and the bobbin 20 such that the movable iron core 23 is kept from contact with the magnetic plate 25. There is no concern for increases in sliding resistance and increases in operating voltage that might otherwise occur due to contact between the movable iron core 23 and the magnetic plate 25.

The length Y of fit between the distal end portion of the movable iron core 23 and the guide portion 4a of the orifice 4 in the direction of the axis L in the state in which the movable iron core 23 is in the initial position is greater than the stroke X of the movable iron core 23. Thus, the distal end of the movable iron core 23 remains fitted in the guide portion 4a and is guided by the guide portion 4a, irrespective of the functioning position of the movable iron core 23. The highly stable functioning of the movable iron core 23 is ensured accordingly.

Although an embodiment of the present invention is illustrated as a three-port valve in the accompanying drawings, the present invention is also applicable to two-port valves.

### REFERENCE SIGNS LIST

1 main valve part
2 electromagnetic operation part
3 valve body
4 orifice
4a guide portion
7 valve chamber
8 valve member
11, 12, 13 flow path cavity
19 coil
20 bobbin
21 bobbin hole
22 fixed iron core
23 movable iron core
24 return spring
25 magnetic plate
26 magnetic cover
30 spring housing hole
31 spring washer
32 spring washer
33 iron core hole
33a small-diameter portion
33b large-diameter portion
34 plate hole
36 recessed groove
L axis
P supply port
A output port
R discharge port
D1, D2, D3 inner diameter
X stroke
Y length

1. An electromagnetic valve, comprising:
a main valve part including a valve member for switching between flow paths; and
an electromagnetic operation part that causes the valve member to perform switching, wherein
the electromagnetic operation part includes
a bobbin with a coil wound therearound,
a bobbin hole extending within and through the bobbin from a proximal end to a distal end of the bobbin,
a fixed iron core that is fixedly housed in the bobbin hole in such a manner that a proximal end of the fixed iron core is adjacent to the proximal end of the bobbin,
a movable iron core that is housed in the bobbin hole in such a manner that a distal end of the movable iron core is adjacent to the distal end of the bobbin, the movable iron core being capable of shifting along an axis of the bobbin hole,
a return spring that is in coil form and places the movable iron core back into an initial position in which the movable iron core sits apart from the fixed iron core,
a magnetic cover that covers the proximal end of the bobbin, the proximal end of the fixed iron core, and the coil, and
a magnetic plate that is adjacent to a distal end portion of the bobbin to provide magnetic coupling between the magnetic cover and the movable iron core, the magnetic plate having a plate hole in which the movable iron core is fitted in a manner so as to be shiftable therein,
the fixed iron core has a spring housing hole extending within and through the fixed iron core along the axis,
the return spring is housed in the spring housing hole,
a proximal end of the return spring is in contact with the magnetic cover, and
a distal end of the return spring is in contact with the movable iron core.

2. The electromagnetic valve according to claim 1, wherein
the movable iron core has an iron core hole extending within and through the movable iron core along the axis, and
the distal end of the return spring is in contact with a proximal end surface of the movable iron core in a manner so as to surround an open end of the iron core hole in the proximal end surface.

3. The electromagnetic valve according to claim 2, wherein
the iron core hole includes
a small-diameter portion having an open end in the proximal end surface of the movable iron core, and
a large-diameter portion having an open end in a distal end surface of the movable iron core, and
an inner diameter of the small-diameter portion is smaller than an inner diameter of the large-diameter portion and is smaller than an inner diameter of the spring housing hole in the fixed iron core.

4. The electromagnetic valve according to claim 1, wherein
the magnetic cover and a recessed spring washer are provided as a one-piece member in such a manner that the recessed spring washer is located in a contact portion where the return spring is in contact with the magnetic cover, and
the movable iron core and another recessed spring washer are provided as a one-piece member in such a manner that the recessed spring washer is located in a contact portion where the return spring is in contact with the movable iron core.

5. The electromagnetic valve according to claim 1, wherein
the main valve part includes
a valve body including a plurality of ports,
an orifice attached to a proximal end portion that is part of the valve body and faces the electromagnetic operation part, and
a valve chamber provided between the orifice and the valve body,
flow path cavities communicating with the respective ports are open to the valve chamber,
the valve member for opening and closing the flow path cavities is housed in the valve chamber,
the orifice includes a guide portion being tubular in shape and extending all along a periphery of a distal end portion of the movable iron core,
the guide portion is caught in a recessed groove extending along an inner periphery of the magnetic plate, and
an inner diameter of the guide portion and an inner diameter of the bobbin hole are each smaller than an inner diameter of the plate hole in the magnetic plate.

6. The electromagnetic valve according to claim 5, wherein a length of fit between the distal end portion of the movable iron core and the guide portion of the orifice in a direction of the axis in a state in which the movable iron core is in the initial position is greater than a stroke of the movable iron core.
